(19) United States
(12) Patent Application Publication
(10) Pub. No.: US 2011/0198016 A1
(43) Pub. Date: Aug. 18, 2011

(54) FIBER REINFORCED THERMOPLASTIC RESIN MOLDING

(75) Inventors: Akira KASUYA, Osaka (JP); Hiroyuki HAMADA, Kyoto (JP); Asami NAKAI, Kyoto (JP)

(73) Assignees: KURASHIKI BOSEKI KABUSHIKI KAISHA, Okayama (JP); National University Corporation Kyoto Institute of Technology, Kyoto-shi (JP)

(21) Appl. No.: 13/097,474

(22) Filed: Apr. 29, 2011

Related U.S. Application Data
(63) Continuation of application No. 11/438,773, filed on May 23, 2006.

(30) Foreign Application Priority Data
Nov. 22, 2005 (JP) 2005-337004

(51) Int. Cl. B32B 7/08; B29C 70/02

(52) U.S. Cl. 156/93; 156/243

(57) ABSTRACT

The present invention provides thermoplastic resin molding fiber that is reinforced with natural fiber. The natural fiber is linen fiber to be twisted into spun yarns, and the spun yarns are pulled parallel in at least one direction and are molded integrally with a thermoplastic resin. The linen fiber is flax yarn (linen) fiber molded into the fiber thermoplastic resin molding by a film-stacking method in which a thermoplastic resin film is melted and compressed while having an equilibrium moisture regain. Consequently, the thermoplastic resin molding reinforced with a plant fiber of the present application poses no environmental problem, has a high strength, and has a uniform physical property.

This application is a Continuation of U.S. application Ser. No. 11/438,773, filed May 23, 2006, which application is incorporated herein by reference.

### BACKGROUND OF THE INVENTION

1. Field of the Invention

The present invention relates to a fiber reinforced thermoplastic resin molding reinforced with natural fiber.

2. Description of Related Art

Plastics are used for the interiors of automobiles, airplanes, vehicles, and the like, and they are lightweight as compared with metal. Since plastics alone have an insufficient strength, short glass fiber (cut to a certain length) is mixed with plastics. However, when such a mixture is disposed of and burned in an incinerator, plastics are decomposed into CO₂ and water, while glass is melted to become solid and is attached to the inside of the incinerator. It is feared, for example, that this significantly shortens the life of incinerators. As a material having a strength as high as glass, carbon fiber is known, which, however, is expensive and thus is not suitable for a practical use.

As a solution to these problems, in recent years, a fiber reinforced thermoplastic (FRTP) resin molding reinforced with natural fiber has been attracting increased social attention, since such a fiber reinforced thermoplastic resin molding brings no environmental problem for the following reasons. That is, this fiber reinforced thermoplastic resin molding is recyclable in such a manner as to be reusable in terms of material recycling and as to emit no poisonous gas when burned in terms of thermal recycling. Further, this fiber reinforced thermoplastic resin molding can provide a lightweight mobile object, which addresses energy problems, and weight reduction can enhance fuel economy. Further, natural plant fiber absorbs carbon dioxide therein during photosynthesis, and emits the same amount of carbon dioxide as before the absorption of carbon dioxide when burned.

A fiber reinforced resin using natural fiber as reinforcing fiber is proposed in Patent documents 1 and 2. Patent document 1 describes a fiber reinforced resin using short linen fiber processed into a nonwoven fabric, a woven fabric, or a knitted fabric. Patent document 2 describes a fiber reinforced resin using short kenaf fiber processed into a nonwoven fabric or a woven fabric.

Patent document 1: JP 2004-143401

Patent document 2: JP 2004-149930

According to Patent document 1 or 2, short linen or kenaf fiber processed into a nonwoven fabric, a woven fabric, or a knitted fabric is used to form a fiber reinforced plastic (FRP) resin. However, when fiber is processed into a nonwoven fabric, it is impossible to increase a volume content (Vf) of fiber in FRP. Thus, a sufficient strength cannot be obtained, and the thickness and the weight of a molding are increased. Further, due to individual differences, differences depending on the place of harvest, and the like specific to natural fiber, it is impossible to ensure a stable physical property. Further, a knitted fabric is formed of yarns having a loop structure, which does not contribute to the strength and the elastic modulus. A woven fabric is formed of warp and weft yarns that cross each other one above the other to form a flat surface. When such a woven fabric is used to form FRP, it is broken at a bent portion under a stress not higher than the strength of fiber.

### SUMMARY OF THE INVENTION

To solve the above-mentioned conventional problems, the present invention provides a fiber reinforced thermoplastic resin molding that poses no environmental problem, has a high strength, and has a uniform physical property.

A fiber reinforced thermoplastic resin molding according to the present invention is reinforced with natural fiber. The natural fiber is twisted into spun yarns, and the spun yarns are pulled parallel in at least one direction and are molded integrally with a thermoplastic resin.

### BRIEF DESCRIPTION OF THE DRAWINGS

FIG. 1A is a plan view showing a method of manufacturing a molding according to one example of the present invention by using a film-stacking method. FIG. 1B is a cross-sectional view showing the manufacturing method.

FIG. 2 is a graph showing a strength-elongation relationship of a fiber reinforced resin according to Example 1 of the present invention.

FIG. 3 is a schematic perspective view of a multiaxial warp knitted fabric as an application example of the present invention.

### DETAILED DESCRIPTION OF THE INVENTION

According to the present invention, natural fiber is twisted into a spun yarn, so that it can be treated as continuous fiber. This makes it possible to increase a volume content (Vf). Since natural fibers are mixed together before a yarn is spun, even when there are individual differences, differences depending on the place of harvest, or the like specific to the natural fiber, a stable physical property can be obtained with no environmental problem. Further, the spun yarns are pulled parallel in at least one direction and are molded integrally with a thermoplastic resin. Thus, unlike a woven fabric, the yarns are not bent at a point where warp and weft yarns cross each other, resulting in a fiber reinforced thermoplastic resin molding having a high strength.

The fiber reinforced thermoplastic resin molding of the present invention is obtained by pulling spun yarns of natural fiber in at least one direction and molding the same integrally with a thermoplastic resin. This results in the afore-mentioned effects. The natural fiber is preferably plant fiber, such as cotton fiber, linen fiber, bamboo fiber, and kapok. In particular, flax yarn (linen) fiber or linen fiber such as flax is preferable, because flax yarn (linen) fiber, which is an annual plant, can be harvested in 3 months and ensures a stable material supply.

It is preferable that the linen fiber is molded into a fiber reinforced thermoplastic resin molding while having an equilibrium moisture regain. This makes it possible to maintain the strength at a high level.

It is preferable that the fiber reinforced thermoplastic resin molding is formed at a temperature not lower than the melting point of a thermoplastic resin and not higher than a temperature 20° C. lower than the decomposition temperature of the natural fiber. If molding is performed at a temperature lower than the melting point of a thermoplastic resin, the thermoplastic resin is not impregnated in the natural fiber. Further, natural fiber is cracked on a cross section of a spun yarn before the decomposition temperature is reached, and the reinforcing strength of the spun yarn starts to be reduced when certain cracks have been produced. Within the above-mentioned temperature range, however, the strength of the fiber reinforced thermoplastic resin molding can be maintained at a high level. In particular, in consideration of the impregnation property of a thermoplastic resin in the natural fiber, it is preferable to perform molding at a temperature as high as possible, such as a temperature 20° C. to 40° C. lower than the decomposition temperature, within the above-mentioned temperature range.

The fiber reinforced thermoplastic resin molding can be manufactured by using a well-known conventional molding method, such as a hot stamping method, a prepreg molding method, and a SMC molding method. It is also possible to use a film-stacking method in which a thermoplastic resin film is melted and compressed. This molding method is suitable for forming a thin sheet.

It is preferable that the spun yarns are pulled parallel in a plurality of directions, and a plurality of arrays of the yarns pulled parallel are bound together with a stitching yarn in a thickness direction to form a multiaxial warp knitted fabric. Consequently, it is possible to obtain a high-strength molding with no angle dependence. For example, a plurality of arrays of the yarns pulled parallel are arranged in a sheet shape, and the obtained 2 or more sheets of the yarns are laminated in different directions. This laminate is bound together with a stitching yarn to form a multiaxial laminated sheet. In this manner, it is also possible to obtain a so-called fiber reinforced plastic having an excellent reinforcement effect in multiple directions. A binder may be used instead of or in combination with a stitching yarn.

Hereinafter, the present invention will be described specifically with reference to examples. The present invention is not limited to the following examples.

### EXAMPLE 1

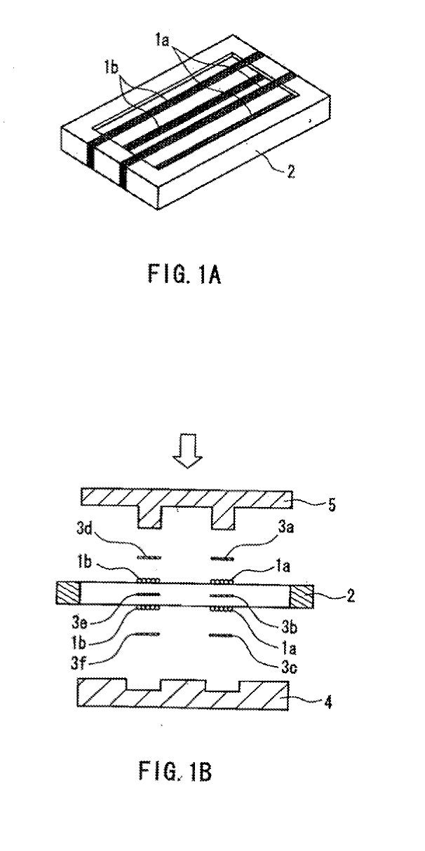

FIG. 1A is a plan view showing a method of manufacturing a molding according to one example of the present invention by using a film-stacking method. FIG. 1B is a cross-sectional view showing the manufacturing method. Spun yarns la and lb made of flax (linen) fiber were wound around a metal frame 2 in one direction as shown in FIG. 1A. The 132 spun yarns, each having a thickness (fineness) of 130 tex, were wound over a width of 20 mm, which had a weight of 3.1 g. As shown in FIG. 1A, the spun yarns were wound around the metal frame 2 at two places with a certain distance therebetween. Each of the spun yarns had 12 turns per inch (472.4 T/m) and a decomposition temperature of about 200° C. As shown in FIG. 1B, polypropylene (PP) films 3a to 3f, each having a melting point of 151° C. and a thickness of 0.2 mm (200 μm), were disposed on both surfaces of the wound spun yarns and therebetween (between the upper and lower yarn surfaces), and the flax (linen) spun yarns and the PP films were melted in a single unit by hot press molds 4 and 5. The temperature of the mold was 160° C. to 190° C., the pressure was 4 MPa, and the time during which heat and pressure were applied was 20 minutes. The ratio of the spun yarns was about 70 mass %.

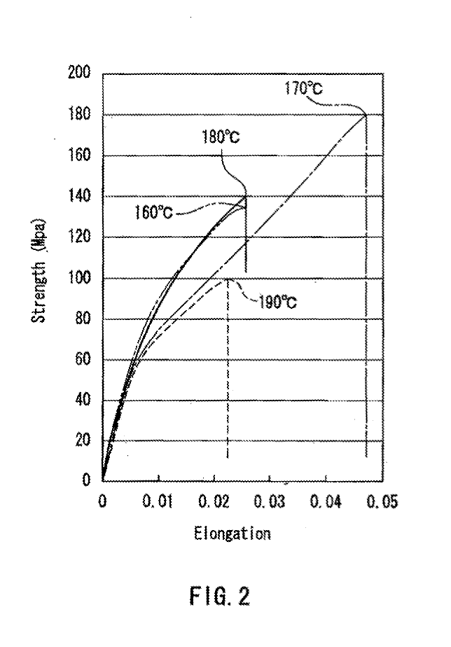

The molding thus obtained was cut to a length of 180 mm to form a tensile specimen (length: 180 mm; width: 20 mm; thickness: about 1.2 mm). A tensile test was performed using Autograph AG-5000B produced by Shimadzu Corporation in accordance with JISK7054: 1995 under the conditions of a distance between clamping devices of 80 mm and a test rate of 1 mm/min. The tensile strength of the fiber reinforced resin molding is shown in Table 1 and FIG. 2.

TABLE 1

Temperature (° C.)

| | 160 | 170 | 180 | 190 |
|---|---|---|---|---|
| Elastic | 21.5 | 23.0 | 24.0 | 23.9 |
| modulus | | | | |
| (GPa) | | | | |
| Strength | 141.9 | 179.1 | 139.1 | 99.9 |
| (GPa) | | | | |

From the above results, it was found that the temperature was preferably 160° C. to 180° C., and most preferably 170° C., although no systematic difference was observed concerning the elastic modulus. The strength became lower at 190° C., which was close to the decomposition temperature.

Further, the obtained fiber reinforced resin molding was observed photographically in section. There was a portion where the resin was not impregnated (hereinafter, referred to as a “nonimpregnated portion”) in the yarns at a temperature of the mold of 160° C. This is thought to be because PP was melted but was not permeated into the yarns yet due to its high viscosity at a temperature of 160° C. At a temperature of the mold of 170° C., the nonimpregnated portion in the yarns was reduced, and the molding was in a uniform state. At a temperature of the mold of 180° C., the fiber in the yarns was defined clearly, and the nonimpregnated portion was formed around the fiber and also around the yarns. It is thought that this was caused as the yarns started to be decomposed. At a temperature of the mold of 190° C., the nonimpregnated portion was spread apparently in the yarns, and cracks were observed. It is thought that this was caused by decomposition of the flax yarns.

### EXAMPLE 2

Next, the effect of moisture was examined. Since natural fiber is highly absorptive, it changes greatly in dynamical physical property due to moisture. Further, it is thought that the existence of moisture during molding results in a nonimpregnated region. Thus, conventionally, the existence of moisture has been considered unfavorable.

First, samples of flax spun yarn alone having different moisture regains were formed under the following conditions.
(1) Drying: performed at 60° C. for 24 hours
(2) Equilibrium moisture regain: left to stand in an indoor environment at 25° C. and at 65% relative humidity; state of having an equilibrium moisture regain
(3) Water absorption: performed at 80° C. in saturated water vapor for 120 hours

The physical property of each of the samples is shown in Table 2.

TABLE 2

| | Elastic | | Moisture |
|---|---|---|---|
| | modulus | Strength | regain |
| State | (GPa) | (GPa) | (%) |
| Dried | 23.1 | 420 | 0 |
| Equilibrium | 23.9 | 500 | 4.4 |
| moisture regain | | | |
| Water absorbed | 20.5 | 620 | 115.8 |

As shown in Table 2, the elastic modulus was substantially the same between the sample subjected to drying and the sample left (in a state of having an equilibrium moisture regain), but was lower in the sample subjected to water absorption. The strength increased with moisture.

Next, the following molding conditions were set to change the moisture regain as follows: temperature: 170° C.; pressure: 4 MPa; time during which heat and pressure were applied: 20 minutes.

Each of the samples was molded in the same manner as in Example 1, and the physical property thereof was measured. The following results were obtained.

TABLE 3

| | | | | Moisture |
|---|---|---|---|---|
| | Elastic | | | regain (%) of |
| | modulus | Strength | Density | yarn when |
| State | (GPa) | (GPa) | (g/cm³) | molded |
| Dried | 20.3 | 15.6 | 1.06 | 0.0 |
| Equilibrium | 21.2 | 179.1 | 0.98 | 4.4 |
| moisture | | | | |
| regain | | | | |
| Water absorbed | 13.5 | 150.1 | 1.04 | 115.8 |

As is evident from Table 3, the elastic modulus was lowest when water was absorbed, which corresponds to the change in physical property of yarns due to moisture. The strength was highest in the sample left (in a state of having an equilibrium moisture regain), which is different from the change in physical property of yarns. This is thought to be because flax yarns shrink by containing water and a remaining stress of compression in the molding is present.

The appearance of the molding was the same between the sample subjected to drying and the sample in a state of having an equilibrium moisture regain. The sample subjected to water absorption contained water even after being molded. The moldings obtained under the respective conditions were observed in section.
(1) In the molding subjected to drying, a matrix resin was impregnated well in the yarns.
(2) In the molding left, a matrix resin was impregnated relatively well in the yarns.
(3) In the molding subjected to water absorption, a crack as a nonimpregnated region was found in the yarns. It is considered that water in the yarns prevented a matrix resin from being impregnated.

From the above results, it was found that there was no particular need to perform drying when using flax spun yarns. In other words, it is most efficient to use flax yarns while they are left at room temperature and are in a state of having an equilibrium moisture regain.

### Application Example

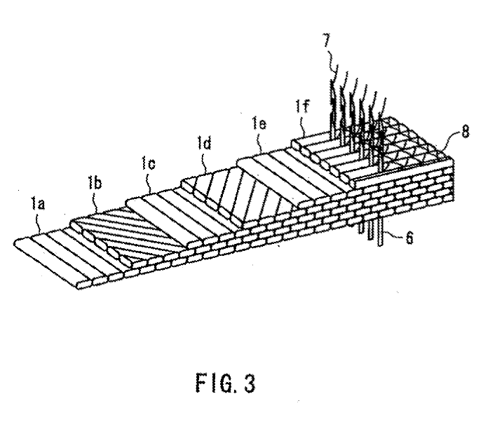

An application example of the present invention is shown in FIG. 3. FIG. 3 is a schematic perspective view of a multiaxial warp knitted fabric. Flax spun yarns 1a to 1f arranged in a plurality of directions were stitched (bound) with stitching yarns 7 and 8 that pass through needles 6, in a thickness direction into a single unit. Such a multiaxial warp knitted fabric can be used as a fiber reinforcing material to be molded integrally with a thermoplastic resin.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1-8. (canceled)

9. A method of manufacturing a fiber reinforced thermoplastic resin molding reinforced with natural fiber, the method comprising:
pulling spun yarns of twisted natural fiber parallel in at least one direction so that a plurality of the spun yarns form a plane, wherein the spun yams are in a form of continuous yarns; and
molding the spun yams and the thermoplastic resin integrally so as to form a sheet by a film-stacking method of heat-melting and compressing a film of the thermoplastic resin,
wherein the molding step of the fiber reinforced thermoplastic resin molding is carried out at a temperature no lower than a melting point of the thermoplastic resin and no higher than a temperature 20° C. lower than the decomposition temperature of the natural fiber, and
the thermoplastic resin is impregnated in the natural fiber.

10. The method of manufacturing a fiber reinforced thermoplastic resin molding according to claim 9, wherein the natural fiber is plant fiber.

11. The method of manufacturing a fiber reinforced thermoplastic resin molding according to claim 9, wherein the natural fiber is linen fiber.

12. The method of manufacturing a fiber reinforced thermoplastic resin molding according to claim 9, wherein the natural fiber is flax yarn fiber.

13. The method of manufacturing a fiber reinforced thermoplastic resin molding according to claim 11, wherein the linen fiber is molded into a fiber reinforced thermoplastic resin molding while having an equilibrium moisture regain.

14. The method of manufacturing a fiber reinforced thermoplastic resin molding according to claim 9, wherein the spun yarns are pulled parallel in a plurality of directions, and a plurality of arrays of the yarns pulled parallel are stitched with a stitching yarn in a thickness direction to form multiaxial knitted layered fabric.
